(19) United States
(12) Patent Application Publication
(10) Pub. No.: US 2012/0103951 A1
(43) Pub. Date: May 3, 2012

(54) CONTROL APPARATUS AND LASER PROCESSING MACHINE

(75) Inventor: Hiroko Takada, Chiyoda-ku (JP)

(73) Assignee: MITSUBISHI ELECTRIC CORPORATION, Chiyoda-ku (JP)

(21) Appl. No.: 13/262,794

(22) PCT Filed: Feb. 7, 2011
(86) PCT No.: PCT/JP2011/052503

§ 371 Date: Oct. 3, 2011

(30) Foreign Application Priority Data
Feb. 8, 2010 (JP) 2010-025339

(51) Int. Cl. B23K 26/00; G06F 17/00

(52) U.S. Cl. 219/121.67; 700/105

(57) ABSTRACT

A control apparatus for controlling a laser processing machine, includes: a HDD as data storing means for storing shape data on a shape of a processed part to which laser processing of the laser processing machine is applied and data on a processing condition of the laser processing machine; and a CPU as processing condition adjusting means for performing adjustment of the processing condition with reference to the shape data and the data on the processing condition stored in the data storing means. The shape data that is acquired as to a work when the work to which the laser processing is applied is determined to be a defective item and the data on the processing condition that is adjusted by the processing condition adjusting means according to the determination of being a defective item are accumulated in the data storing means in association with each other.

### FIELD

The present invention relates to a control apparatus and a laser processing machine including the control apparatus.

### BACKGROUND

Conventionally, when a processing defect is found in laser processing, the processing condition is changed according to the state of the processed part and the processing is repeated. The processing condition is adjusted by operator's empirically-based decisions, coping methods displayed on a processing help screen, and the like according to the state of the processed part when the processing defect is observed. For example, Patent Literature 1 proposes a technology on a processing machine expertise support system which displays a list of a plurality of change causes that represent the causes of defects, and displays all information on selected causes of defects as a condition change list. Changes to make are selected from the displayed condition change list, and the settings of the processing machine are changed to resolve the causes of the defective item.

### CITATION LIST

### Patent Literature

Patent Literature 1: Japanese Patent Application Laid-open No. 2003-99501

### SUMMARY

### Technical Problem

In laser processing, a processing defect is often resolved by adjusting two or more parameters of the processing condition. The decisions about which parameters to select from the plurality of parameters displayed in the list and to what extent to change the parameters are up to the operator. Depending on the processing expertise the operator has, a large number of trials and a lot of time may therefore be needed before the resolution of a processing defect. The processing accuracy required of laser processing often varies by product type or by user. It is therefore desired that the processing condition be also adjustable as appropriate to the processing accuracy required.

The present invention has been achieved in view of the foregoing, and it is an object thereof to provide a control apparatus that allows adjustment of the processing condition appropriate to a desired processing accuracy and allows resolution of processing defects irrespective of the level of processing expertise, and a laser processing machine that includes the control apparatus.

### Solution to Problem

In order to solve the aforementioned problems and attain the aforementioned object, the control apparatus for controlling a laser processing machine is provided with: data storing means for storing shape data on a shape of a processed part to which laser processing of the laser processing machine is applied, and data on a processing condition of the laser processing machine; and processing condition adjusting means for performing adjustment of the processing condition with reference to the shape data and the data on the processing condition stored in the data storing means, wherein the shape data that is acquired as to a work when the work to which the laser processing is applied is determined to be a defective item, and the data on the processing condition that is adjusted by the processing condition adjusting means according to a determination of being a defective item, are accumulated in the data storing means in association with each other.

### Advantageous Effects of Invention

The present invention has the effect that it is possible to adjust the processing condition as appropriate to a desired processing accuracy and resolve processing defects irrespective of the level of processing expertise.

### BRIEF DESCRIPTION OF DRAWINGS

FIG. 1 is a block diagram showing the configuration of a laser processing machine according to an embodiment.

FIG. 2 is a diagram showing a display example of display means.

FIG. 3 is a flowchart for explaining the procedure for adjusting a processing condition.

### DESCRIPTION OF EMBODIMENTS

Hereinafter, an embodiment of the control apparatus and the laser processing machine according to the present invention will be described in detail with reference to the drawings. It should be noted that the present invention is not limited by this embodiment.

### Embodiment

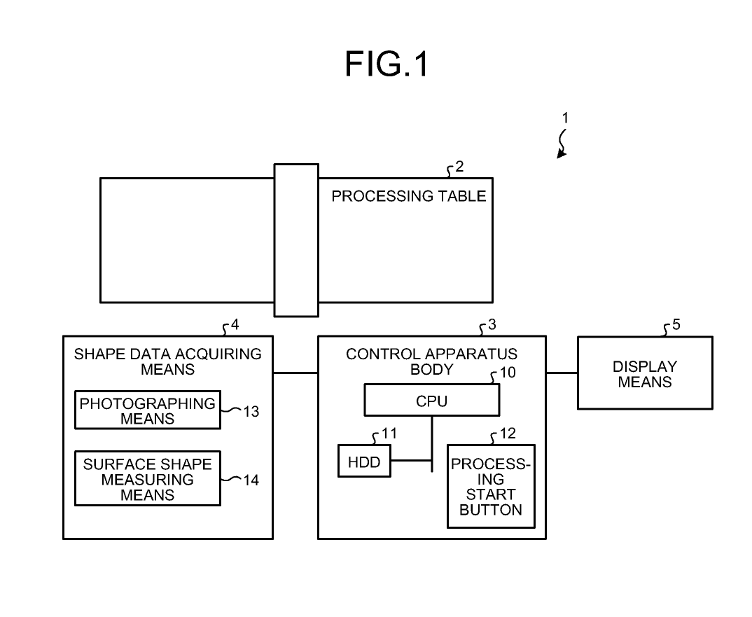

FIG. 1 is a block diagram showing the configuration of a laser processing machine 1 according to the embodiment of the present invention. The laser processing machine 1 includes a processing table 2, a control apparatus body 3, shape data acquiring means 4, and display means 5. A plate material is placed on the processing table 2. The control apparatus body 3, the shape data acquiring means 4, and the display means 5 constitute a control apparatus for controlling the laser processing machine 1.

The control apparatus body 3 includes a CPU 10, a HDD 11, and a processing start button 12. The CPU 10 executes various types of arithmetic processing for controlling the laser processing machine 1. The HDD 11 being data storing means contains a database. Shape data on the shape of processed parts to which the laser processing of the laser processing machine 1 is applied, and data on the processing condition of the laser processing machine 1 are registered in the database, as well as data on work materials and data on thickness, for example.

The CPU 10 functions as processing condition adjusting means for performing adjustment of the processing condition with reference to the shape data, the data on the processing condition, and the like registered in the database. The processing start button 12 accepts an input operation for starting the laser processing of the laser processing machine 1.

The shape data acquiring means 4 is connected to the control apparatus body 3 through a LAN, for example.

The shape data acquiring means 4 is intended to acquire shape data on the shape of a processed part, and includes photographing means 13 and surface shape measuring means 14. The photographing means 13 is a camera for photographing a processed part. The surface shape measuring means 14 measures the surface roughness of a surface processed by the laser processing. For example, the surface shape measuring means is a surface profiler of optical scanning type. It should be noted that the shape data acquiring means 4 has only to include at least either the photographing means 13 or the surface shape measuring means 14.

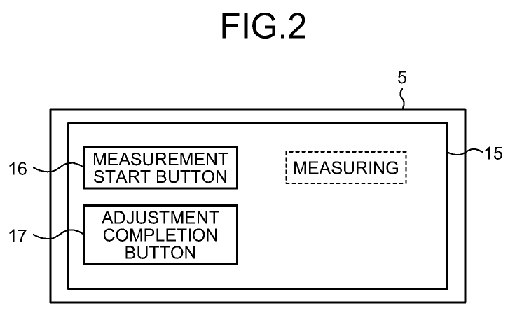

FIG. 2 is a diagram showing a display example of the display means 5. For example, the display means 5 is a CRT display having a screen 15 that functions as a touch panel. The display example shown here is where the measurement of the shape data acquiring means 4 is in process. A measurement start button 16 and an adjustment completion button 17 are displayed on the screen 15. The measurement start button 16 accepts an input operation for starting the measurement of the shape data acquiring means 4. The adjustment completion button 17 is adjustment completion inputting means for accepting an input operation for completing adjustment of the processing condition. To indicate the current status of the laser processing machine 1, a message “MEASURING” is displayed on the screen 15, beside the measurement start button 16 and the adjustment completion button 17.

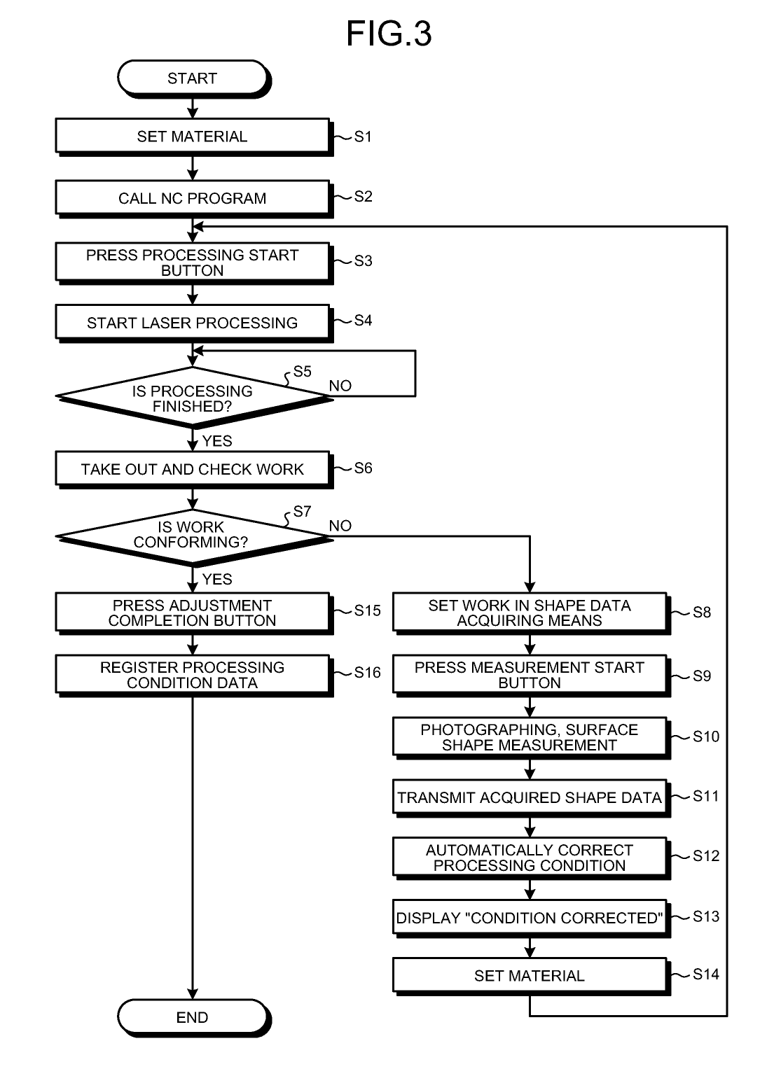

FIG. 3 is a flowchart for explaining the procedure for adjusting the processing condition. In step S1, a material is set on the processing table 2. In step S2, an NC program for laser processing is called. In step S3, the operator presses the processing start button 12. In step S4, laser processing is started. The laser processing is performed according to the called NC program and a processing condition that is set as initial values. In step S5, whether the laser processing is finished or not is determined. If the laser processing is determined not to be finished yet (step S5, No), the laser processing started in step S4 is continued. If the laser processing is determined to have finished (step S5, Yes), then in step S6, the processed work is taken out and the operator checks the work for a processing defect.

If a processing defect is found by the checking in step S6 and the work is determined to be a defective item (determined not to be a conforming or good item) (step S7, No), the operator sets the work determined to be a defective item into the shape data acquiring means 4 (step S8). In step S9, the operator presses the measurement start button 16. In step S10, the photographing means 13 performs photographing, and the surface shape measuring means 14 performs a measurement.

Among examples of major forming failures in laser processing are the adhesion of dross to the backside of the plate material and stripes of asperities formed on the processed surface. The shape data acquiring means 4 acquires data on the shape and size of dross mainly by photographing using the photographing means 13. The shape data acquiring means 4 also acquires data on the asperities on the processed surface mainly by measurement using the surface shape measuring means 14. The shape data acquiring means 4 digitizes such data into shape data.

For evaluation, the operator has only to determine whether or not the processed item constitutes a processing defective. Which mode of processing defects the item corresponds to is accurately and objectively determined by the measurement by the shape data acquiring means 14. The shape data acquired by the shape data acquiring means 4 is transmitted to the control apparatus body 3 by network communication or serial communication (step S11). The message “MEASURING” is displayed on the screen 15 of the display means 5, for example, between when the shape data acquiring means 4 starts measurement and when the transmission of the shape data to the control apparatus body 3 is completed.

Next, the control apparatus body 3 makes an automatic correction to the processing condition through arithmetic operations of the CPU 10 (step S12). In step S12, the data on the processing condition that is registered in association with the material and thickness of the work that causes the processing defect, and the shape data acquired by the shape data acquiring means 4 are read out. The read data and the current processing condition are compared, and corrections are made to implement a processing condition that is best suited to the resolution of the processing defect.

Examples of parameters of the processing condition to be adjusted include the focal position of the laser, gas pressure, processing feed speed, the output power of the laser, and nozzle gap. For a processing defect of dross adhesion, corrections such as lifting the focal position, increasing the gas pressure, and reducing the processing feed speed are made. For a processing defect of producing stripes of asperities on the processed surface, corrections such as lifting or lowering the focal position and decreasing the gas pressure are made. The focal position is changed in units of 0.5 mm, for example. Which parameters to be adjusted to select and to what extent to change are appropriately corrected according to the mode of the processing defect, such as the particle size or shape in the case of dross, and the shape of stripes and the height and intervals of asperities in the case of stripes of asperities. The method to cope with a processing defect also varies depending on the material and thickness. The parameters of the processing condition to be adjusted have only to be at least one, and may be more than one. The parameters of the processing condition to be adjusted are not limited to those described in the present embodiment, and may be added as appropriate.

When the correction of the processing condition is completed, then in step S13, a message such as “CONDITION CORRECTED” is displayed on the screen 15 of the display means 5. Next, in step S14, a material is set again. In step S3, the operator presses the processing start button 12, and the laser processing is started again under the adjusted processing condition (step S4). In step S7, if the work is determined again to be a defective item (step S7, No), the procedure of step S8 and subsequent steps is repeated.

If, in step S7, the work is determined to be a conforming item (step S7, Yes), then in step S15, the operator presses the adjustment completion button 17. In response to the depression of the adjustment completion button 17, the data on the processing condition when the work is determined to be a conforming or good item is registered in the database along with the shape data acquired by the shape data acquiring means 4 (step S16). This is the end of the adjustment of the processing condition. It should be appreciated that the data on the work material and the data on the thickness to be registered in the database may be those previously stored in the HDD 11 or those input on such occasions as the beginning of processing and the beginning of measurement.

The foregoing adjustment of the processing condition is repeated on the laser processing machine 1. As a result, shape data that is acquired as to works when the works are determined to be a defective item and the data on the processing condition that is adjusted by the processing condition adjusting means according to the determination of being a defective item, are accumulated in the data storing means in association with each other. It should be appreciated that initial values of the data on the processing condition and the shape data may be previously stored in the HDD 11 before the data accumulation through the processing of the laser processing machine 1.

Based on the data on the processing condition stored in the database, the processing condition can be adjusted to resolve a processing defect with a fewer number of trials and in a shorter time of adjustment operations irrespective of the level of processing expertise the operator has. Each time a processing defect is observed in the laser processing, the shape data and the data on the adjusted processing condition are accumulated. This allows adjustment of the processing condition appropriate to a processing accuracy required of the laser processing with respect to each product type and each user. Consequently, there is provided an effect that it is possible to adjust the processing condition as appropriate to a desired processing accuracy and resolve processing defects irrespective of the level of processing expertise.

The control apparatus according to the present embodiment may be applied to a conventional laser processing machine. The control apparatus has only to include at least the control apparatus body 3, and may be configured without the shape data acquiring means 4 or the display means 5.

### INDUSTRIAL APPLICABILITY

As described above, the control apparatus and the laser processing machine according to the present invention are useful in making it possible to resolve processing defects irrespective of the level of the operator's processing expertise.

### REFERENCE SIGNS LIST

1 LASER PROCESSING MACHINE
4 SHAPE DATA ACQUIRING MEANS
5 DISPLAY MEANS
10 CPU (PROCESSING CONDITION ADJUSTING MEANS)
11 HDD (DATA STORING MEANS)
13 PHOTOGRAPHING MEANS
14 SURFACE SHAPE MEASURING MEANS
17 ADJUSTMENT COMPLETION BUTTON (ADJUSTMENT COMPLETION INPUTTING MEANS)

1. A control apparatus for controlling a laser processing machine, comprising:
data storing means for storing shape data on a shape of a processed part to which laser processing of the laser processing machine is applied, and data on a processing condition of the laser processing machine; and
processing condition adjusting means for performing adjustment of the processing condition with reference to the shape data and the data on the processing condition stored in the data storing means, wherein
the shape data that is acquired as to a work when the work to which the laser processing is applied is determined to be a defective item, and the data on the processing condition that is adjusted by the processing condition adjusting means according to a determination of being a defective item, are accumulated in the data storing means in association with each other.

2. The control apparatus according to claim 1, wherein data on the processing condition when a work to which the laser processing is applied is determined to be a conforming item, is registered in the data storing means.

3. The control apparatus according to claim 1, comprising adjustment completion inputting means for accepting an input operation for completing the adjustment by the processing condition adjusting means, and wherein
the data on the processing condition is registered in the data storing means according to the input operation to the adjustment completion inputting means.

4. The control apparatus according to claim 1, wherein the data storing means further stores data on at least either one of a material and a thickness of the work.

5. The control apparatus according to claim 1, comprising shape data acquiring means for acquiring the shape data.

6. The control apparatus according to claim 5, wherein the shape data acquiring means includes at least either photographing means for photographing the processed part or surface shape measuring means for measuring surface roughness of the processed part resulting from the laser processing.

7. A laser processing machine comprising a control apparatus that includes:
data storing means for storing shape data on a shape of a processed part to which laser processing of the laser processing machine is applied, and data on a processing condition of the laser processing machine; and
processing condition adjusting means for performing adjustment of the processing condition with reference to the shape data and the data on the processing condition stored in the data storing means, wherein
the shape data that is acquired as to a work when the work to which the laser processing is applied, is determined to be a defective item and the data on the processing condition that is adjusted by the processing condition adjusting means according to a determination of being a defective item are accumulated in the data storing means in association with each other.
